(19) United States
(12) Patent Application Publication
(10) Pub. No.: US 2017/0329503 A1
(43) Pub. Date: Nov. 16, 2017

(54) EDITING ANIMATIONS USING A VIRTUAL REALITY CONTROLLER

(71) Applicant: GOOGLE INC., Mountain View, CA (US)

(72) Inventors: Robbie TILTON, San Francisco, CA (US); Robert Carl JAGNOW, Mountain View, CA (US)

(21) Appl. No.: 15/595,447

(22) Filed: May 15, 2017

Related U.S. Application Data
(60) Provisional application No. 62/336,202, filed on May 13, 2016.

(51) Int. Cl. G06F 3/0484; G06F 3/01; G06F 1/16

(52) U.S. Cl. CPC G06F 3/04845; G06F 3/011; G06F 1/1694; G06F 3/0484

(57) ABSTRACT

Techniques of computer animation involve embedding a keyframe editor within a virtual reality (VR) controller that displays animation objects within a VR environment on a VR display to enable editing of early keyframes. The keyframe editor allows a user to select a keyframe of an animation sequence for editing using the VR controller. The keyframe may be one that is placed before the end of the animation sequence. The keyframe editor also allows the user to select, via the VR controller, an aspect of the animation object to change within the selected keyframe. When an animation object follows a first trajectory before editing, the keyframe editor may automatically generate a second trajectory that preserves continuity of action.

### CROSS REFERENCE TO RELATED APPLICATION(S)

This application claims priority to U.S. Provisional Application No. 62/336,202, filed on May 13, 2016, the disclosure of which is incorporated herein by reference in its entirety.

### TECHNICAL FIELD

This description generally relates to editing computer animations.

### BRIEF DESCRIPTION OF THE DRAWINGS

FIG. 1 is a flowchart of an example method of performing improved techniques of editing an animation.

FIG. 2 is a block diagram depicting an example electronic environment for performing the improved techniques of editing an animation.

FIG. 3A is a diagram depicting an example virtual reality (VR) display that displays an animation to a user having a VR controller.

FIG. 3B is a diagram depicting the example VR display displaying another edited animation to the user.

FIG. 4 is a diagram depicting another example VR display that displays an animation to a user having a VR controller.

FIG. 5 is a diagram depicting another example VR display that displays an animation to a user having a VR controller.

FIG. 6 is a diagram depicting another example VR display that displays an animation to a user having a VR controller.

FIG. 7 is a diagram depicting another example VR display that displays an animation to a user having a VR controller.

FIG. 8 is a diagram depicting an example of a computer device and a mobile computer device that can be used to implement the techniques described herein.

FIG. 9 is a diagram depicting an example VR head-mounted display (HMD).

FIGS. 10A, 10B and 10C is a diagram depicting the example VR HMD and controller.

Like reference symbols in the various drawings indicate like elements.

### DETAILED DESCRIPTION

Conventional computer animation techniques involve keyframe animation and/or motion capture. In keyframe animation, an animator may specify precise mathematical trajectories of an animation object over time. In motion capture, an animator may capture the movements of an actor at various points to define trajectories of an animation object over time.

However, in keyframe animation or motion capture, it is difficult to edit earlier keyframes in an animation sequence without introducing inconsistencies and/or discontinuities.

A keyframe is an animation frame that defines a start and/or end of a smooth transition of the motion of an animation object. An animation sequence includes a sequence of frames that define a smooth motion of an animation object. However, only some of those frames—the keyframes—are actually drawn and edited. Other frames, the in-between frames, are filler frames that create the illusion of movement to a viewer.

An improved technique of computer animation involves embedding a keyframe editor within a virtual reality (VR) controller that displays animation objects within a VR environment on a VR display to enable editing of early keyframes. The keyframe editor allows a user to select a keyframe of an animation sequence for editing using the VR controller. The keyframe may be one that is placed before the end of the animation sequence. The keyframe editor also allows the user to select, via the VR controller, an aspect of the animation object to change within the selected keyframe. When an animation object follows a first trajectory before editing, the keyframe editor may automatically generate a second trajectory that preserves continuity of action.

The keyframe editor embedded in the VR controller provides a simple way to produce and/or edit computer animations using existing hardware. The VR editor also allows for a three-dimensional editing experience that the conventional computer animation techniques do not allow. Further, the VR editor allows editing while an animation is being recorded, i.e., in real time.

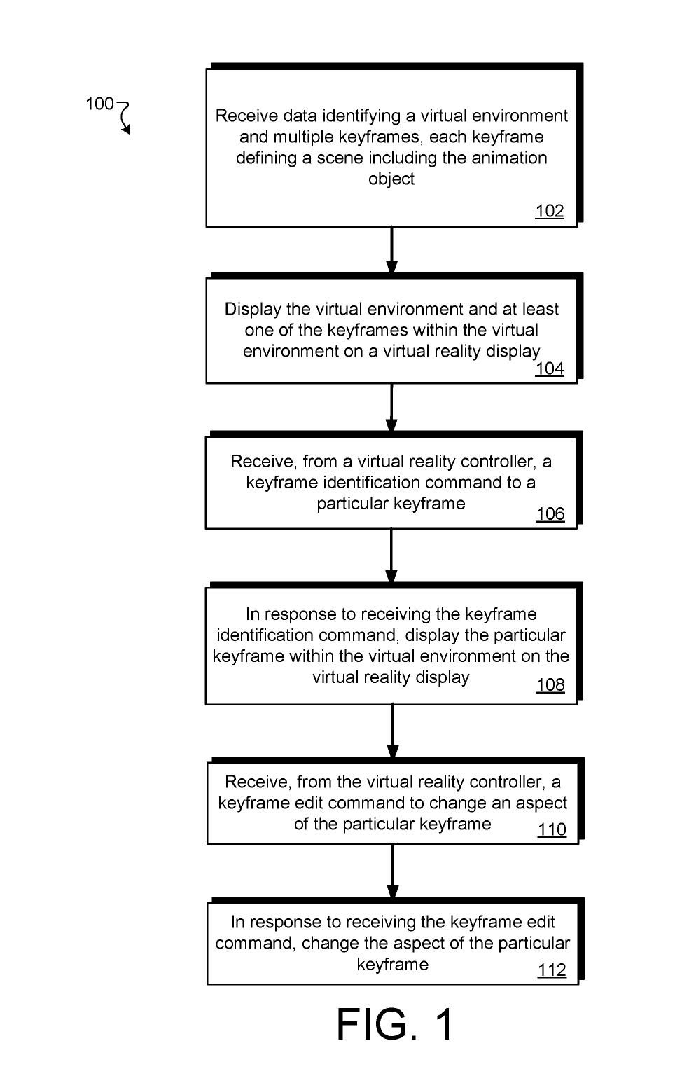

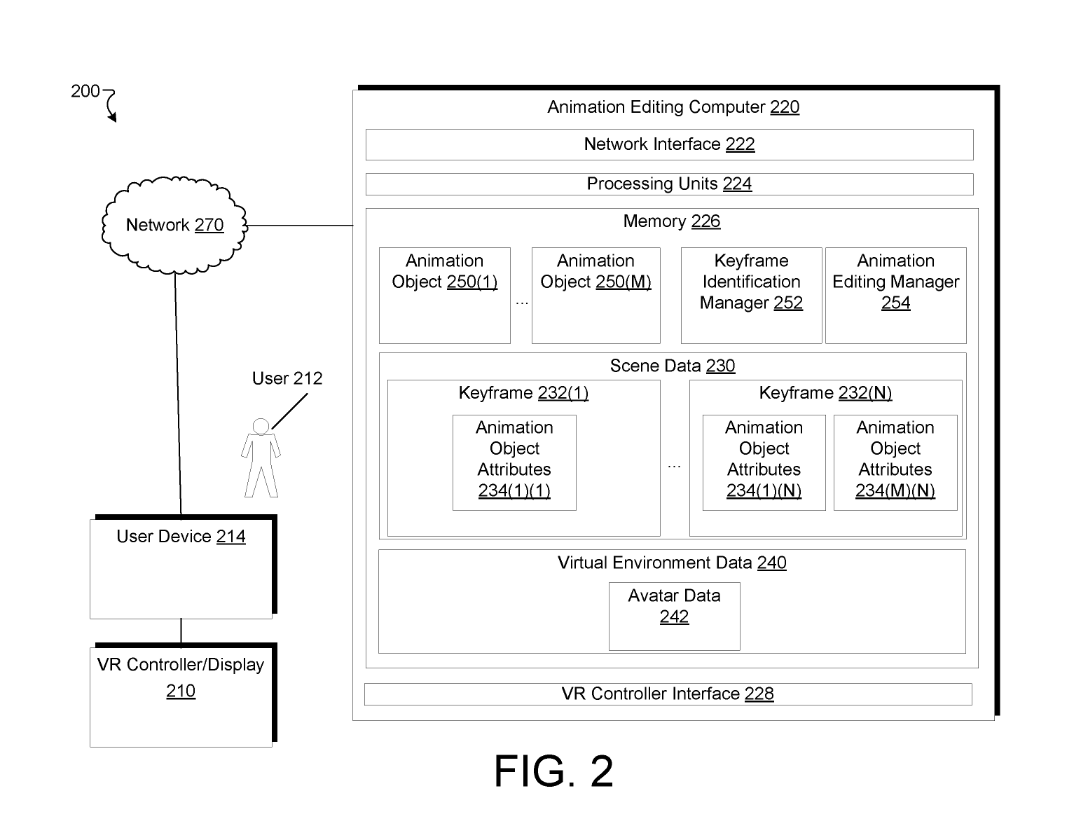

FIG. 1 is a flowchart illustrating an example method 100 for performing the improved techniques. The method 100 is performed by an animation editing computer, described below with reference to FIG. 2.

At 102, the animation editing computer receives data defining a virtual environment and multiple keyframes, each keyframe defining a scene including the animation object at a respective point in time. For example, the data may originate from an already-recorded animation sequence stored in a data store. Alternatively, the data may be received from a live recording of a motion capture animation. The animation object may be a rendering of a person, an animal, or any other object of interest to a viewer.

At 104, the animation editing computer displays the virtual environment and at least one of the plurality of keyframes within the virtual environment on a VR display. For example, the keyframes may be referenced within a timeline shown in the display.

At 106, the animation editing computer receives, from a VR controller, a keyframe identification command identifying a particular keyframe of the at least one of the plurality of keyframes displayed within the virtual environment on the VR display. A user, e.g., an editor, views the animation sequence while immersed in the virtual environment, represented by an avatar. In this way, the user can identify a keyframe for display by pointing to a place in the timeline via the avatar.

At 108, the animation editing computer displays the particular keyframe within the virtual environment on the VR display.

At 110, the animation editing computer receives, from the VR controller, a keyframe edit command to change an aspect of the particular keyframe. An aspect of a keyframe may include a position, shape, and/or size of an object in that keyframe. For example, the user may move the animation object around the virtual environment by “grabbing” the object via the avatar.

At 112, the animation editing computer changes the aspect of the particular keyframe in response to receiving the keyframe edit command.

FIG. 2 is a block diagram of an example electronic environment 200 for performing the method 100 described in FIG. 1. The electronic environment 200 includes a VR controller/display 210, a user device 214, the animation editing computer 220, and a network 270.

The VR controller 210 may take the form of a head-mounted display (HMD) which is worn by a user 112 to provide an immersive virtual environment. In the example electronic environment 200, the user 212 that wears the VR controller 210 holds a user device 214. The user device 214 may be, for example, a smartphone, a controller, a joystick, or another portable handheld electronic device(s) that may be paired with, and communicate with, the VR controller 210 for interaction in the immersive virtual environment. The user device 214 may be operably coupled with, or paired with the VR controller 210 via, for example, a wired connection, or a wireless connection such as, for example, a WiFi or Bluetooth connection. This pairing, or operable coupling, of the user device 214 and the VR controller 210 may provide for communication between the user device 214 and the VR controller 210 and the exchange of data between the user device 214 and the VR controller 210. This may allow the user device 214 to function as a controller in communication with the VR controller 210 for interacting in the immersive virtual environment. That is, a manipulation of the user device 214, such as, for example, a beam or ray emitted by the user device 214 and directed to a virtual object or feature for selection, and/or an input received on a touch surface of the user device 214, and/or a movement of the user device 214, may be translated into a corresponding selection, or movement, or other type of interaction, in the immersive virtual environment provided by the VR controller 210.

The animation editing computer 220 is configured and arranged to perform the method 100 described in FIG. 1. Specifically, the animation editing computer 220 is configured and arranged to enable editing of keyframes used in animation sequences within a virtual environment. As illustrated in FIG. 2, the animation editing computer 220 is implemented as a computer system that is in communication with the user device 214 over the network 270.

In some implementations, the animation editing computer 220 can be, for example, a wired device and/or a wireless device (e.g., wi-fi enabled device) and can be, for example, a computing entity (e.g., a personal computing device), a server device (e.g., a web server), a mobile phone, a touchscreen device, a personal digital assistant (PDA), a laptop, a television, a tablet device, e-reader, and/or so forth. Such device(s) can be configured to operate based on one or more platforms (e.g., one or more similar or different platforms) that can include one or more types of hardware, software, firmware, operating systems, runtime libraries, and/or so forth.

The animation editing computer 220 includes a network interface 222, a set of processing units 224, memory 226, and a VR controller interface 228. The network interface 222 includes, for example, Ethernet adaptors, Token Ring adaptors, and the like, for converting electronic and/or optical signals received from the network 270 to electronic form for use by the animation editing computer 220. The set of processing units 224 include one or more processing chips and/or assemblies. The memory 226 includes both volatile memory (e.g., RAM) and non-volatile memory, such as one or more ROMs, disk drives, solid state drives, and the like. The set of processing units 224 and the memory 226 together form control circuitry, which is configured and arranged to carry out various methods and functions as described herein.

The components (e.g., modules, processing units 224) of the animation editing computer 220 can be configured to operate based on one or more platforms (e.g., one or more similar or different platforms) that can include one or more types of hardware, software, firmware, operating systems, runtime libraries, and/or so forth. In some implementations, the components of the animation editing computer 220 can be configured to operate within a cluster of devices (e.g., a server farm). In such an implementation, the functionality and processing of the components of the animation editing computer 220 can be distributed to several devices of the cluster of devices.

The components of the animation editing computer 220 can be, or can include, any type of hardware and/or software configured to process attributes. In some implementations, one or more portions of the components shown in the components of the animation editing computer 220 in FIG. 2 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the animation editing computer 220 can be, or can include, a software module configured for execution by at least one processor (not shown). In some implementations, the functionality of the components can be included in different modules and/or different components than those shown in FIG. 2.

Although not shown, in some implementations, the components of the animation editing computer 220 (or portions thereof) can be configured to operate within, for example, a data center (e.g., a cloud computing environment), a computer system, one or more server/host devices, and/or so forth. In some implementations, the components of the animation editing computer 220 (or portions thereof) can be configured to operate within a network. Thus, the components of the animation editing computer 220 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the animation editing computer 220 can be, or can include, processors configured to process instructions stored in a memory. For example, a keyframe identification manager 252 (and/or a portion thereof) and/or an animation editing manager 254 (and/or a portion thereof) can be a combination of a processor and a memory configured to execute instructions related to a process to implement one or more functions.

In some implementations, the memory 226 can be any type of memory such as a random-access memory, a disk drive memory, flash memory, and/or so forth. In some implementations, the memory 226 can be implemented as more than one memory component (e.g., more than one RAM component or disk drive memory) associated with the components of the animation editing computer 220. In some implementations, the 226 can be a database memory. In some implementations, the memory 226 can be, or can include, a non-local memory. For example, the memory 226 can be, or can include, a memory shared by multiple devices (not shown). In some implementations, the memory 226 can be associated with a server device (not shown) within a network and configured to serve the components of the animation editing computer 220. As illustrated in FIG. 2, the memory 226 is configured to store various data, including animation objects 250(1), . . . , 250(M), scene data 230, and virtual environment data 240.

Each of the animation objects, e.g., animation object 250(1) represents a character in an animation sequence that appears to move along a trajectory within the virtual environment. The animation object 250(1) is partially defined by values of a set of character attributes that define aspects of the character in each keyframe, e.g., what kind of animal, color, number of limbs, and so on. However, the animation object 250(1) is also defined by a set of motion attributes that dictates how each aspect of the character may change from keyframe to keyframe. In one example, the set of motion attributes of the animation object 250(1) includes locations of contact points by which the animation object 250(1) may be manipulated. At each contact point, user 212 may invoke a change in an aspect of the animation object within a keyframe. For example, the user 212, in the form of an avatar, may interact with a limb of the animation object 250(1) via a contact point to move that limb to a different position.

The keyframe identification manager 252 is configured and arranged to identify and select a particular keyframe that is selected for an edit by the user 212. In some arrangements, the keyframe identification manager 252 may identify a keyframe by a keyframe number. In this case, the user might submit the number of the keyframe as part of a request to edit that keyframe. Alternatively, the keyframe identification manager 252 may identify a keyframe using a timeline that tracks the progress of an animation object, e.g., animation object 250(1), during playback of an animation sequence. In this case, the user may select a point in time from the timeline; the point in time would then provide an identification of a keyframe for editing.

The animation editing manager 254 is configured and arranged to provide editing capabilities for a selected keyframe. In some implementations, the animation editing manager 254 is configured to enable an avatar of the user to manipulate an animation object within the selected keyframe as part of the editing process. Further, the animation editing manager 254 is configured to generate a new trajectory for the animation object through subsequent keyframes based on changes made to the animation object in the selected keyframe.

The scene data 230 defines the content of the animation sequence being editing by the animation editing computer 220. The scene data 230 includes a plurality of keyframes 232(1), . . . , 232(N).

Each keyframe, e.g., keyframe 232(1) includes data representing an animation frame that defines a start and/or end of a smooth transition of the motion of an animation object and are actually drawn and edited. Other frames, the in-between frames (not shown), are filler frames that create the illusion of movement to a viewer and are automatically generated from the keyframes 232(1), . . . , 232(N). The keyframe 232(1) is seen in FIG. 2 to include data defining the attributes 234(1)(1) of the animation object 250(1). It should be appreciated that the values of these attributes will change from keyframe to keyframe, e.g., the animation object 250(1) has different attribute values 234(1)(1) in keyframe 232(1) than in keyframe 234(1)(N).

For example, suppose that the animation object is a person. In keyframe 232(1), the person may be seen by the viewer in a first position e.g., with arms to the side and to the left within the virtual environment. In keyframe 232(N), the person may have moved to the right within the virtual environment with arms out. Each of these scenarios are captured with the respective animation object attributes 234(1)(1) and 234(1)(N). Further, the number of animation objects in a keyframe may change from keyframe to keyframe. For example, while keyframe 232(1) is depicted as having one animation object, keyframe 232(N) is depicted as having two.

In some implementations, each keyframe, e.g., keyframe 232(1) also contains data indicating a linear velocity and rotational velocity of an animation object, e.g., animation object 250(1). The linear velocity and rotational velocity may each be defined with respect to a fixed coordinate system. Further, the animation editing manager 254 may use the data indicating the linear velocity and rotational velocity with respect to a fixed coordinate system in order to generate the in-between frames.

The virtual environment data 240 represents the virtual environment in which the editing of the animation sequence takes place. The virtual environment data includes avatar data 242 that represents, for example, a controller used by an editor within the virtual environment to select keyframes, e.g., keyframe 232(1) and contact points on an animation object, e.g., animation object 250(1).

The VR controller interface 228 includes hardware and software configured and arranged to communicate with the VR controller 210 via the user device 214 over the network 270.

The electronic environment 200 depicted in FIG. 2 is part of a generic implementation of a virtual reality system. In such a system, there may be a number of transmitters that emit a signal over a physical space that is received by one or more handheld controllers held by a user to track the motion of the user within the physical space. The handheld controllers are in communication with the animation editing computer 220 to translate the position of the user from the physical space to the virtual environment. The user wears a HMD to effect the immersive virtual reality editing environment. In this case, the handheld controllers and the HMD together form the VR controller 210 and the user device 214. Further, the user sees, as their avatar, an image of the handheld controllers in the display of the HMD. The user then effects edits by selecting objects and/or aspects of objects within the virtual environment generated by the animation editing computer 220.

During example operation, the user 212, via VR controller 210, loads an animation sequence containing scene data 230 into the memory 226 of the animation editing computer 220. In some implementations, as the animation sequence loads, the user 212 experiences the virtual environment generated by the animation editing computer 220 from data sent via the VR controller 210.

Once loaded, the animation editing computer 220 sends images of the keyframes 232(1), . . . , 232(N) to the user device 214 for display. For example, when the user 212 is wearing a HMD, the user may see the keyframes 232(1), . . . , 232(N) within the virtual environment generated by the animation editing computer 220 from the virtual environment data 240. In this example, the user 212 may see an image of handheld controllers as an avatar.

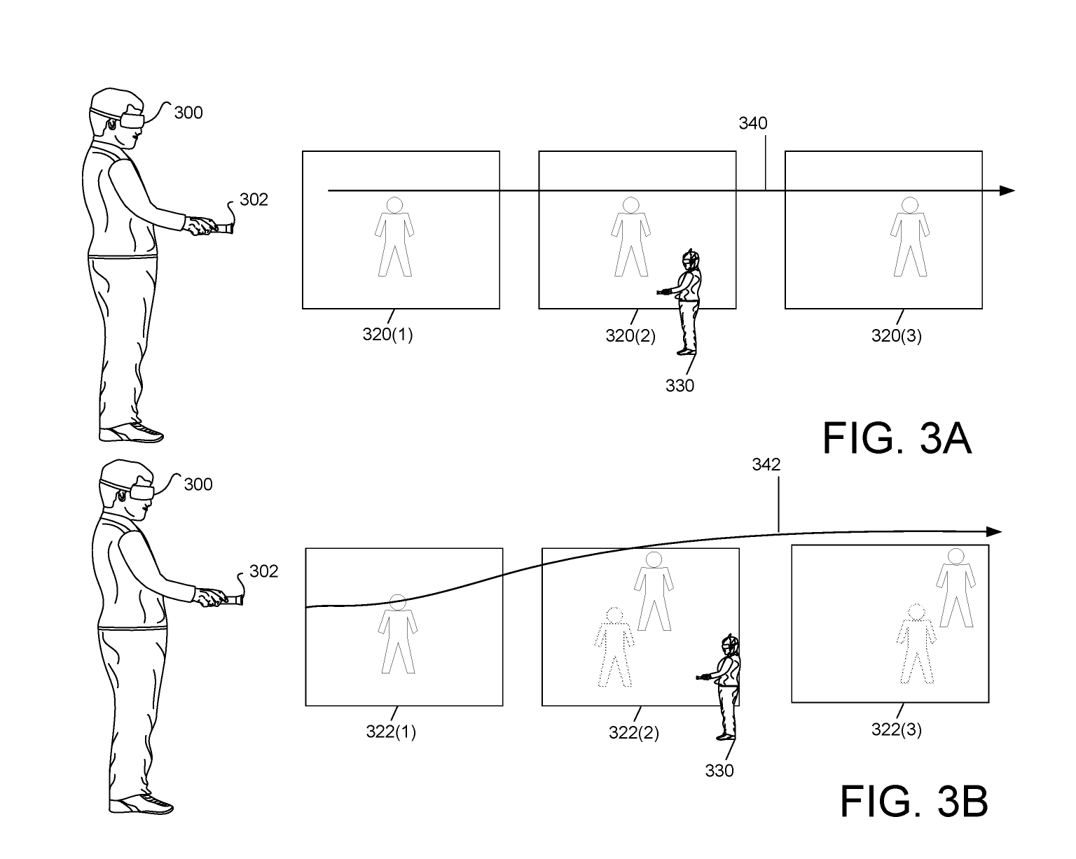

FIG. 3A depicts an example scene on which an editing operation is performed by the animation editing computer 220 (FIG. 2). As depicted in FIG. 3A, a user interacts with the animation editing computer 220 via a HMD 300 and controller 302. The user views the animation sequence loaded into the animation editing computer 220 in the VR display 310 within the HMD 300.

FIG. 3A shows a simple animation sequence that includes a number of keyframes 320(1), 320(2), and 320(3). Each of the keyframes includes a simple, human character in a single position. A playback of the animation sequence results in the animation object following a simple trajectory 340.

FIG. 3A also depicts an avatar 330 of the user within the virtual environment displayed within the VR display 310. As the user moves the controller 302, the avatar will move within the display 310. The user, via the avatar 330, may select one of the keyframes to edit, e.g., keyframe 320(2).

FIG. 3B depicts the example scene in FIG. 3A after an edit effected by the user and performed by the animation editing computer 220. In this example, the user, via avatar 330, has edited the keyframe 320(2) by moving the animation object in the keyframe 320(2) to another position to produce an edited keyframe 322(2).

After the animation editing computer 220 produces the new keyframe 322(2) with the animation object in the new position, the animation editing computer 220 generates a new keyframe 322(3) corresponding to the keyframe 320(3). For example, the animation editing computer 220 may generate the new keyframe 322(3) based on the trajectory 340. Alternatively, the animation editing computer 220 may generate the new keyframe 322(3) based on a desired final position of the animation object in a final keyframe. In any case, a playback of the edited animation may result in the animation object following a new trajectory 342 depicted in FIG. 3B.

This editing operation is an edit of the animation sequence at an early point in time in the sequence. Such edits are typically very difficult to perform using conventional editing techniques because each keyframe must be edited separately. Nevertheless, these edits are relatively simple to perform using the animation editing computer 220.

FIG. 3B also depicts the keyframes 322(2) and 322(3) including the animation character “ghosted” out in its original positions. Along these lines, the animation editing computer 220 leaves a lightened version of the animation character in place. During playback, the user can view the edited animation sequence with the animation object in its new trajectory as well as in its old trajectory for comparison.

To summarize, the animation editing computer 220 is able to integrate editing mechanisms into a virtual environment. Accordingly, an editor using the VR controller 210 may edit keyframes such as 320(2) either after the fact or in real time, i.e., during the recording of the animation. The editor may define a new trajectory of an animation object—a virtual object in the virtual environment—based on a start point in a first keyframe (e.g., keyframe 322(2)) and an end point in a second keyframe (e.g., keyframe 322(3)).

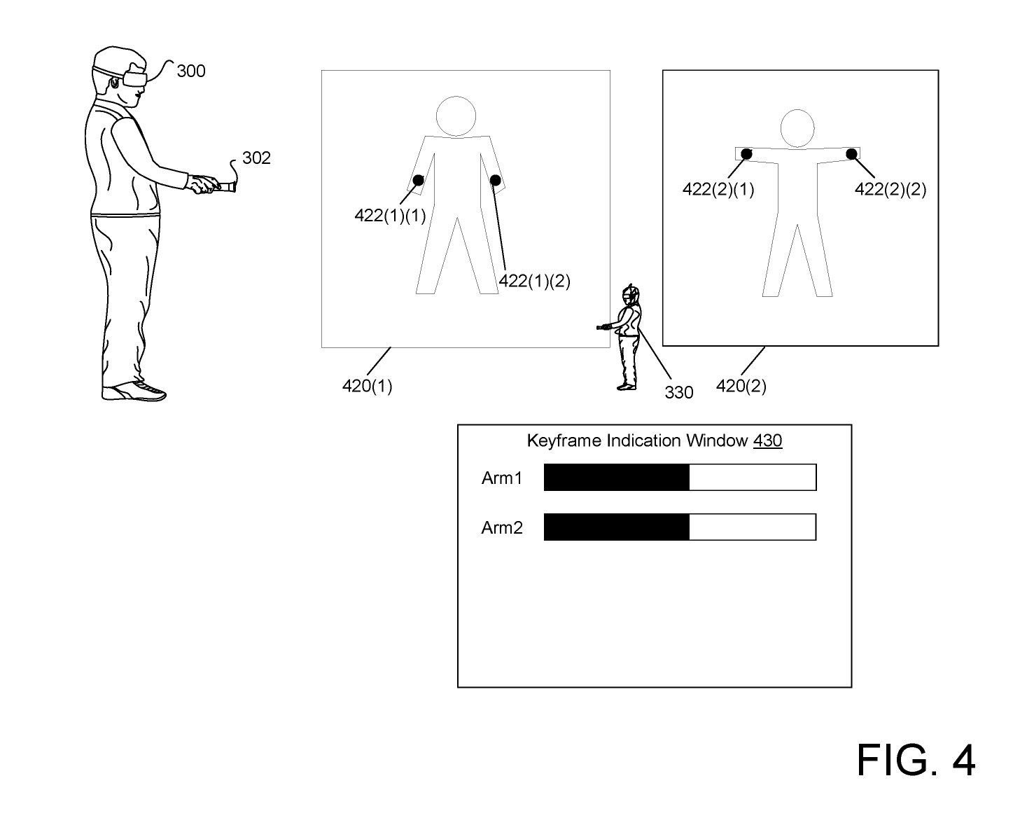

FIG. 4 depicts another example editing operation performed by the animation editing computer 220 (FIG. 2). Specifically, FIG. 4 shows a keyframe 420(1) that includes a simple human character as an animation object. The human character has two contact points 422(1)(1) and 422(1)(2), one in each arm. The user via the avatar 330 may manipulate the human character by interacting with a contact point with the avatar 330.

When the keyframes 420(1) and 420(2) are recorded in real time, the contact points 422(1)(1) and 422(1)(2) provide functionality similar to motion capture. In motion capture, an actor is equipped with sensors at contact points so that the actor's motion at the contact points may be recorded. The animation editing computer 220 may use the motion recorded at these contact points to define the trajectory obeyed by an animation object. Specifically, the animation editing computer 220 may define a trajectory at each of the contact points by e.g., recording a linear velocity and rotational velocity at that contact point. Further, a user may change the trajectory of motion at a contact point by editing an earlier keyframe, e.g., keyframe 420(1).

As depicted in FIG. 4, the user may select the keyframe 420(1) for editing using a keyframe indication window 430. The keyframe indication window 430 tracks the location of each keyframe in an animation sequence over time during a playback. As an animation object moves through a trajectory in the virtual environment, the keyframe indication window 430 denotes the progress of the animation in time. The keyframe indication window 430 also tracks the editable attributes of the animation object in each keyframe. In the example shown in FIG. 4, each arm (“Arm1”, “Arm2”) is represented in the keyframe indication window 430.

Once the user, via the avatar 330, selects the keyframe 420(1) using the keyframe indication window 430, the user may effect an edit of the keyframe 420(1) by using the avatar to move the animation object at the contact points 422(1)(1) and 422(1)(2). In the example depicted in FIG. 4, the animation editing computer 220 changes the position of the arms of the animation character in response to the edit effected by the user via the avatar 330 to produce keyframe 420(2). The edited keyframe 420(2) has arms in a raised position with contact points 422(2)(1) and 422(2)(2).

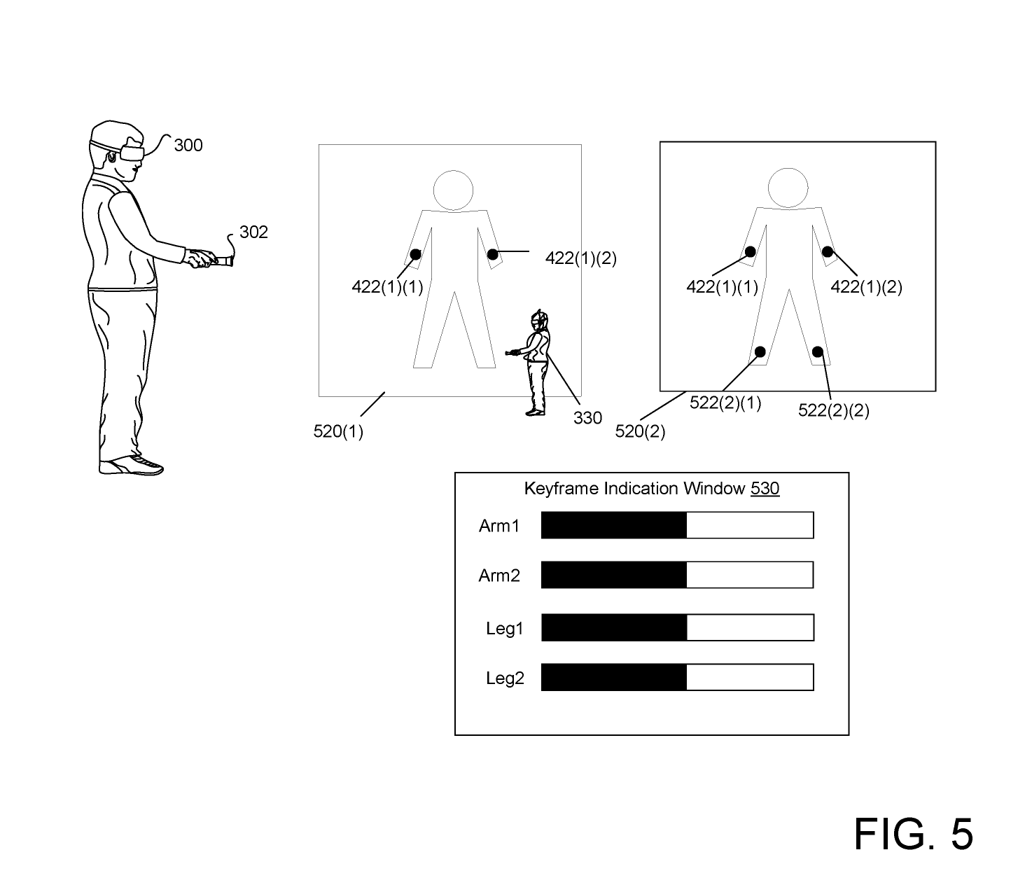

FIG. 5 depicts another example editing operation performed by the animation editing computer 220 (FIG. 2). Specifically, FIG. 5 shows an editing operation in which two new contact points are added to an animation object in a selected keyframe 520(1). Along these lines, in addition to the contact points 422(1)(1) and 422(1)(2) in the arms of the human character in keyframe 520(1), there are now contact points 522(2)(1) and 522(2)(2) in the legs of the human character. The user may effect such an edit by pointing to the legs of the human character with the controller and executing a control (e.g., pushing a button on the controller).

In the example depicted in FIG. 5, the animation editing computer 220 adds the attributes “Leg1” and “Leg2” to the keyframe indication window 530 after the animation editing computer 220 places the contact points in the legs of the human character in response to the user effecting this edit. However, in other arrangements, the keyframe indication window 530 stores a list of all possible attributes for which a contact point may be assigned and only shows a progress bar for those attributes that are active.

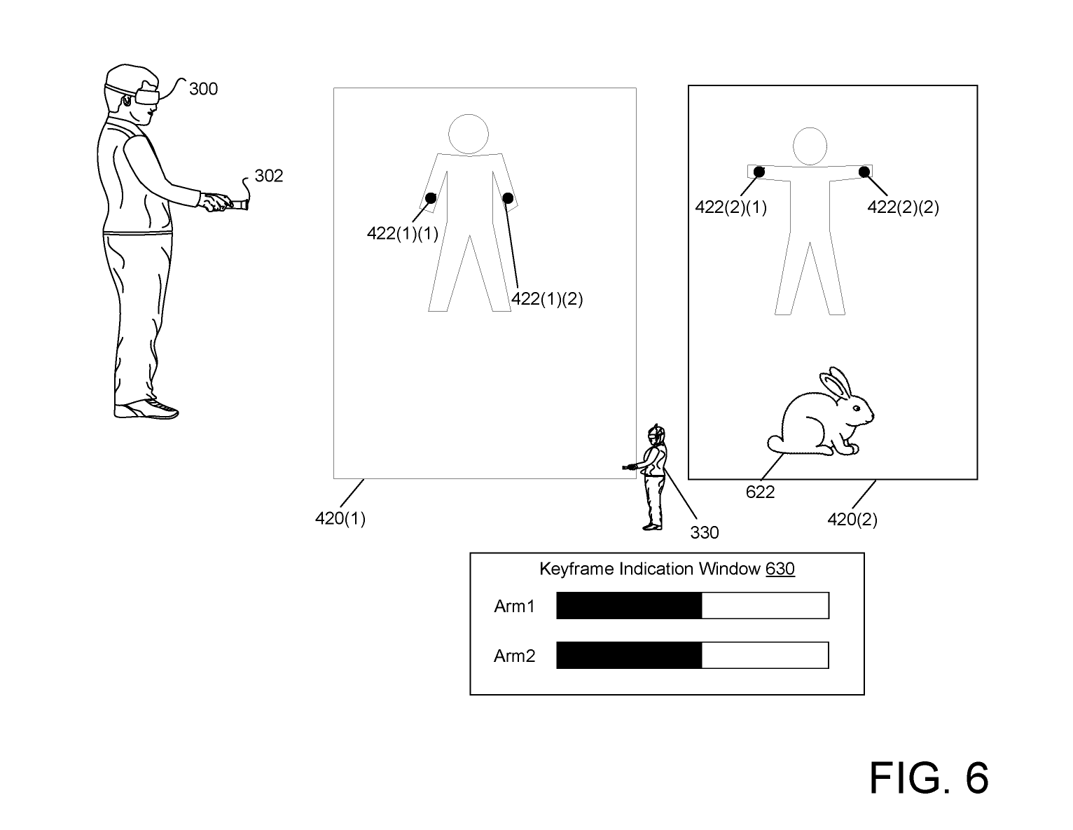

FIG. 6 depicts another example editing operation performed by the animation editing computer 220 (FIG. 2). Specifically, FIG. 6 shows an editing operation in which a new animation object 622 is added to the keyframe 420(1) to produce the edited keyframe 420(2). In this case, the new animation object 622 is a rabbit that may or may not interact with the original human character during the animation sequence.

During this example editing operation, the user, via the avatar 330. May select the new animation object 622 from a library of such objects. Such a library may be located in a virtual storeroom within the virtual environment or may otherwise be present somewhere in the virtual environment. The user via the avatar 330 then places the new object in a location within the selected keyframe. During a playback operation, the user via avatar 330 may move the new animation object 622 around relative to the original animation object. During a subsequent playback, the resulting edited animation sequence will show the new animation object 622 moving according to the placement by the avatar 330.

In some implementations, the user may effect such an edit by controlling the new animation object 622 (or any other animation object of a keyframe) so that the new animation object 622 becomes the avatar of the user. An advantage of this approach is a tighter integration between the motion of the user and the subsequent motion of the animation object 622. In some implementations, the user may only be able to control, for example, the front legs of the new animation object 622. In that case, the animation editing computer 220 may automatically generate motions for the other attributes (e.g., hind legs, head, tail) of the new animation object 622 in subsequent keyframes.

As depicted in FIG. 6, there is only a single keyframe indication window 630 as the new animation object 622 has no contact points defined on it. However, in some implementations, the animation editing computer 220 may generate a separate keyframe indication window for the new animation object 622.

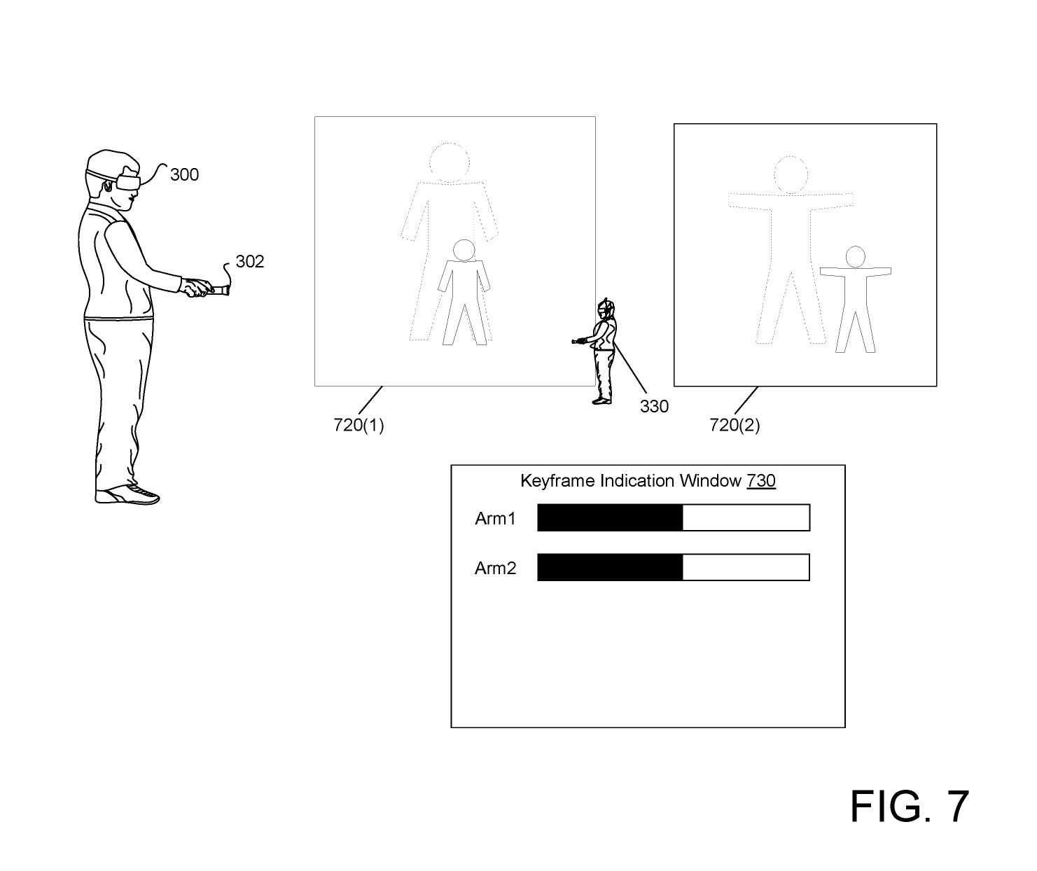

FIG. 7 depicts another example editing operation performed by the animation editing computer 220 (FIG. 2). Specifically, FIG. 7 shows an editing operation in which an animation object is rescaled within a keyframe 720(1). In a subsequent keyframe 720(1), the animation object is shown at the new size. In some arrangements, the animation editing computer 220 preserves a copy of the animation object at the previous size within each of the keyframes 720(1) and 720(2). In some implementations, the shape and/or material properties of an animation object may be changed during the editing process described herein.

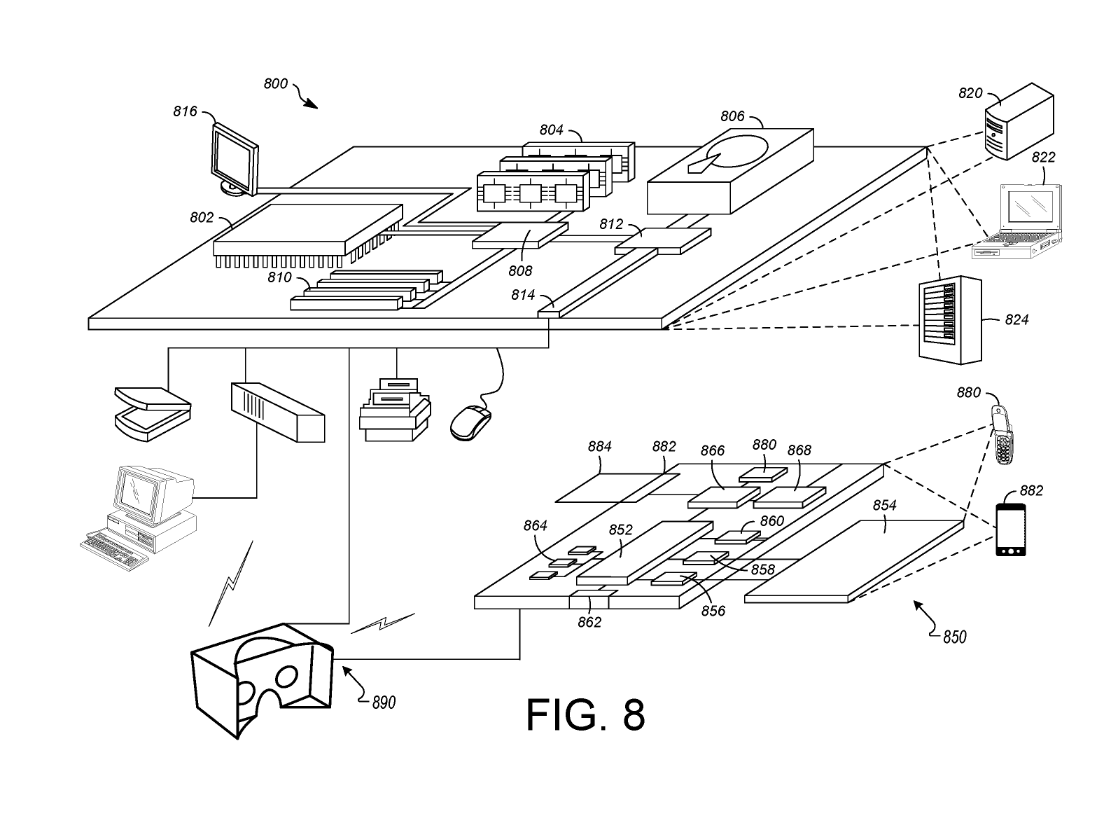

FIG. 8 shows an example of a generic computer device 800 and a generic mobile computer device 850, which may be used with the techniques described here. Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. In addition, multiple computing devices 800 may be connected, with each device providing portions of the necessary operations (e.g., as a server bank, a group of blade servers, or a multi-processor system).

The memory 804 stores information within the computing device 600. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 600. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 600, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 600, 850, and an entire system may be made up of multiple computing devices 600, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, Wi-Fi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 8 can include sensors that interface with a virtual reality (VR headset 890). For example, one or more sensors included on a computing device 850 or other computing device depicted in FIG. 8, can provide input to VR headset 890 or in general, provide input to a VR space. The sensors can include, but are not limited to, a touchscreen, accelerometers, gyroscopes, pressure sensors, biometric sensors, temperature sensors, humidity sensors, and ambient light sensors. The computing device 850 can use the sensors to determine an absolute position and/or a detected rotation of the computing device in the VR space that can then be used as input to the VR space. For example, the computing device 850 may be incorporated into the VR space as a virtual object, such as a controller, a laser pointer, a keyboard, a weapon, etc. Positioning of the computing device/virtual object by the user when incorporated into the VR space can allow the user to position the computing device to view the virtual object in certain manners in the VR space. For example, if the virtual object represents a laser pointer, the user can manipulate the computing device as if it were an actual laser pointer. The user can move the computing device left and right, up and down, in a circle, etc., and use the device in a similar fashion to using a laser pointer.

In some implementations, one or more input devices included on, or connect to, the computing device 850 can be used as input to the VR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 850 when the computing device is incorporated into the VR space can cause a particular action to occur in the VR space.

In some implementations, a touchscreen of the computing device 850 can be rendered as a touchpad in VR space. A user can interact with the touchscreen of the computing device 850. The interactions are rendered, in VR headset 890 for example, as movements on the rendered touchpad in the VR space. The rendered movements can control objects in the VR space.

In some implementations, one or more output devices included on the computing device 850 can provide output and/or feedback to a user of the VR headset 890 in the VR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 850 may appear as another object in a computer-generated, 3D environment. Interactions by the user with the computing device 850 (e.g., rotating, shaking, touching a touchscreen, swiping a finger across a touch screen) can be interpreted as interactions with the object in the VR space. In the example of the laser pointer in a VR space, the computing device 850 appears as a virtual laser pointer in the computer-generated, 3D environment. As the user manipulates the computing device 850, the user in the VR space sees movement of the laser pointer. The user receives feedback from interactions with the computing device 850 in the VR space on the computing device 850 or on the VR headset 890.

In some implementations, one or more input devices in addition to the computing device (e.g., a mouse, a keyboard) can be rendered in a computer-generated, 3D environment. The rendered input devices (e.g., the rendered mouse, the rendered keyboard) can be used as rendered in the VR space to control objects in the VR space.

Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

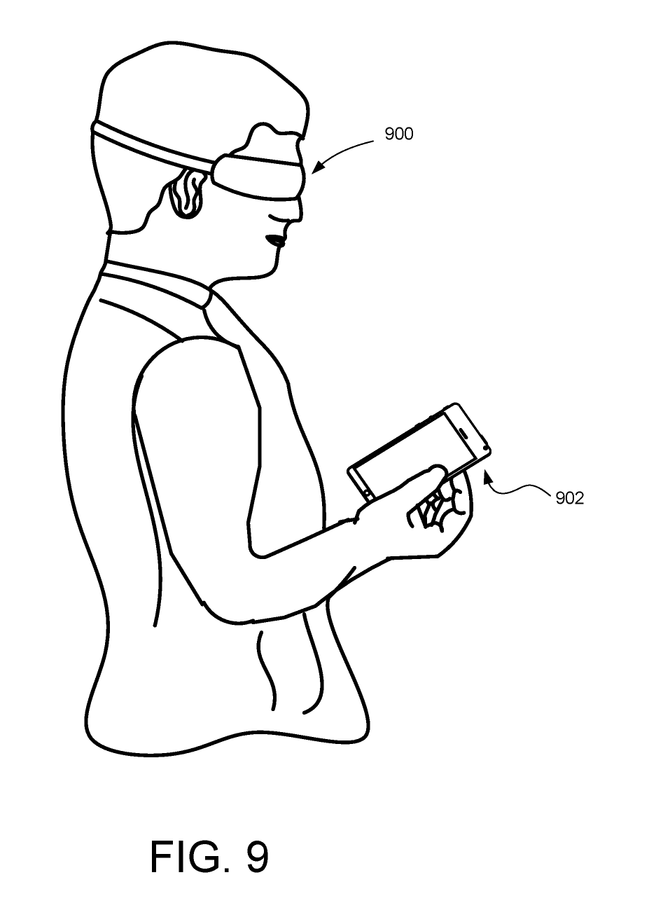

FIG. 9 illustrates an example implementation of a head-mounted display as shown in FIGS. 3-7. In FIG. 9, a user wearing an HMD 900 is holding a portable handheld electronic device 902. The handheld electronic device 902 may be, for example, a smartphone, a controller, a joystick, or another portable handheld electronic device(s) that may be paired with, and communicate with, the HMD 900 for interaction in the immersive virtual environment generated by the HMD 900. The handheld electronic device 902 may be operably coupled with, or paired with the HMD 900 via, for example, a wired connection, or a wireless connection such as, for example, a WiFi or Bluetooth connection. This pairing, or operable coupling, of the handheld electronic device 902 and the HMD 900 may provide for communication between the handheld electronic device 902 and the HMD 900 and the exchange of data between the handheld electronic device 902 and the HMD 900. This may allow the handheld electronic device 902 to function as a controller in communication with the HMD 900 for interacting in the immersive virtual environment generated by the HMD 900. That is, a manipulation of the handheld electronic device 902, such as, for example, a beam or ray emitted by the handheld electronic device 902 and directed to a virtual object or feature for selection, and/or an input received on a touch surface of the handheld electronic device 902, and/or a movement of the handheld electronic device 902, may be translated into a corresponding selection, or movement, or other type of interaction, in the immersive virtual environment generated by the HMD 900. For example, the HMD 900, together with the handheld electronic device 902, may generate a virtual environment as described above, and the handheld electronic device 902 may be manipulated to effect a change in scale, or perspective, of the user relative to the virtual features in the virtual environment as described above.

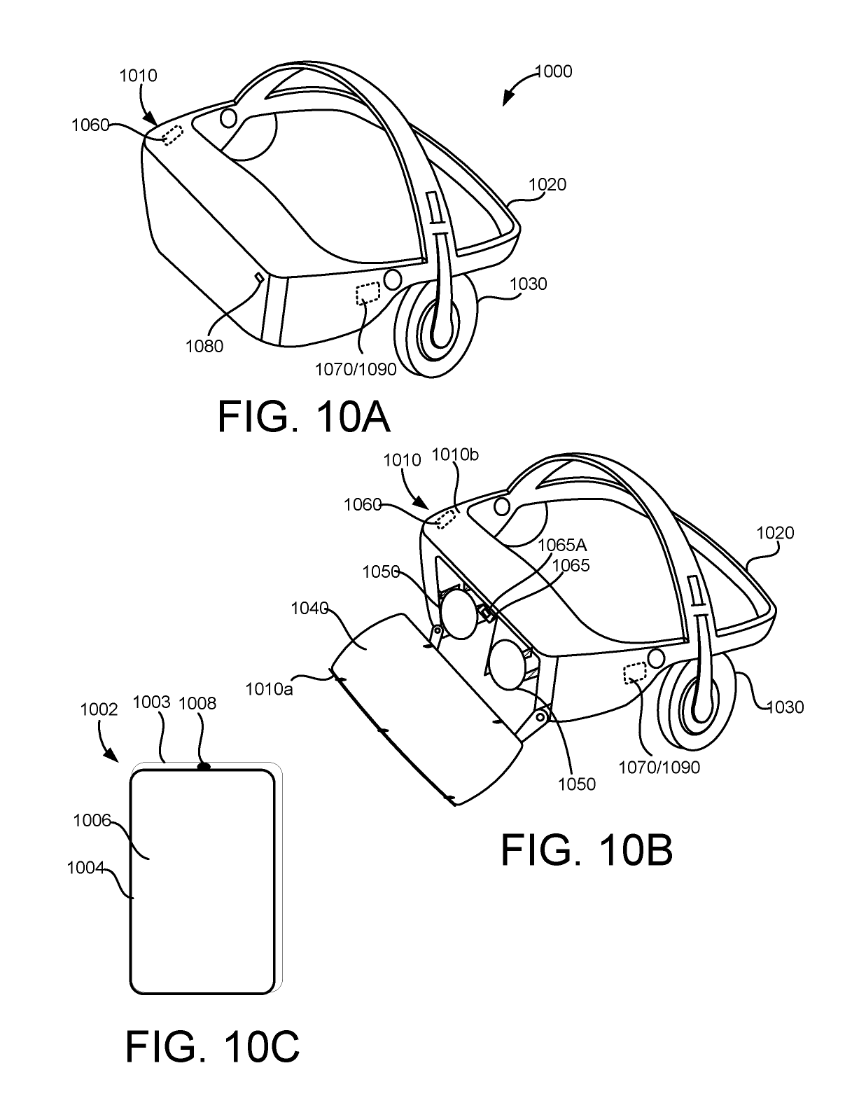

FIGS. 10A and 10B are perspective views of an example HMD, such as, for example, the HMD 900 worn by the user in FIG. 9, and FIG. 2C illustrates an example handheld electronic device, such as, for example, the handheld electronic device 902 shown in FIG. 9.

The handheld electronic device 902 may include a housing 903 in which internal components of the device 902 are received, and a user interface 904 on an outside of the housing 903, accessible to the user. The user interface 904 may include a touch sensitive surface 906 configured to receive user touch inputs. The user interface 904 may also include other components for manipulation by the user such as, for example, actuation buttons, knobs, joysticks and the like. In some implementations, at least a portion of the user interface 904 may be configured as a touchscreen, with that portion of the user interface 904 being configured to display user interface items to the user, and also to receive touch inputs from the user on the touch sensitive surface 906. The handheld electronic device 902 may also include a light source 908 configured to selectively emit light, for example, a beam or ray, through a port in the housing 903, for example, in response to a user input received at the user interface 904.

The HMD 900 may include a housing 910 coupled to a frame 920, with an audio output device 930 including, for example, speakers mounted in headphones, also be coupled to the frame 920. In FIG. 2B, a front portion 910a of the housing 910 is rotated away from a base portion 910b of the housing 910 so that some of the components received in the housing 910 are visible. A display 940 may be mounted on an interior facing side of the front portion 910a of the housing 910. Lenses 950 may be mounted in the housing 910, between the user's eyes and the display 940 when the front portion 910a is in the closed position against the base portion 910b of the housing 910. In some implementations, the HMD 900 may include a sensing system 9160 including various sensors and a control system 970 including a processor 990 and various control system devices to facilitate operation of the HMD 900.

In some implementations, the HMD 900 may include a camera 980 to capture still and moving images. The images captured by the camera 980 may be used to help track a physical position of the user and/or the handheld electronic device 902 in the real world, or physical environment relative to the virtual environment, and/or may be displayed to the user on the display 940 in a pass through mode, allowing the user to temporarily leave the virtual environment and return to the physical environment without removing the HMD 900 or otherwise changing the configuration of the HMD 900 to move the housing 910 out of the line of sight of the user.

In some implementations, the HMD 900 may include a gaze tracking device 965 to detect and track an eye gaze of the user. The gaze tracking device 965 may include, for example, an image sensor 965A, or multiple image sensors 965A, to capture images of the user's eyes, for example, a particular portion of the user's eyes, such as, for example, the pupil, to detect, and track direction and movement of, the user's gaze. In some implementations, the HMD 900 may be configured so that the detected gaze is processed as a user input to be translated into a corresponding interaction in the immersive virtual experience.

Further implementations are summarized in the following examples:

### EXAMPLE 1

A computer-implemented method, the method comprising: receiving data defining a virtual environment and a plurality of keyframes, each keyframe from the plurality of keyframes defining a scene including an animation object at a respective point in time; displaying the virtual environment and at least one of the plurality of keyframes within the virtual environment on a virtual reality display; receiving, from a virtual reality controller, a keyframe identification command identifying a particular keyframe of the at least one of the plurality of keyframes displayed within the virtual environment on the virtual reality display; in response to receiving the keyframe identification command, displaying the particular keyframe within the virtual environment on a virtual reality display; and receiving, from the virtual reality controller, a keyframe edit command identifying an aspect of the particular keyframe; and in response to receiving the edit command, changing the aspect of the particular keyframe identified by the keyframe edit command.

### EXAMPLE 2

The computer-implemented method of example 1, wherein the animation object moves in a first trajectory within the virtual environment between an initial time and a final time during the scene; wherein the particular keyframe defines the animation object at a point in time prior to the final time; and wherein the method further comprises generating a second trajectory over which the animation object is defined between the point in time and the final time.

### EXAMPLE 3

The computer-implemented method of example 2, further comprising, in response to generating the second trajectory, displaying a ghost animation object on the virtual reality display, the ghost animation object moving in the first trajectory within the virtual environment between the point in time and the final time during the scene.

### EXAMPLE 4

The computer-implemented method of any one of examples 1 to 3, wherein the animation object includes a set of contact points, each of the set of contact points providing a point on the animation object at which the virtual reality controller causes the aspect of the animation object to change between adjacent keyframes; and wherein changing the aspect of the identified keyframe includes translating one of the set of contact points to a new position within the virtual environment.

### EXAMPLE 5

The computer-implemented method as in example 4, wherein the virtual reality controller includes a six-degree-of-freedom (6 DOF) controller, and wherein changing the aspect of the identified keyframe further includes rotating the contact point about an axis within the virtual environment.

### EXAMPLE 6

The computer-implemented method as in example 4, wherein changing the aspect of the identified keyframe includes adding a new contact point to the set of contact points of the animation object at the identified keyframe.

### EXAMPLE 7

The computer-implemented method as in any one of examples 1 to 6, further comprising, in response to receiving the edit command, adding another animation object to the scene at the identified keyframe.

### EXAMPLE 8

The computer-implemented method as in any one of examples 1 to 7, wherein changing the aspect of the identified keyframe includes changing a size of the animation object within the virtual environment.

### EXAMPLE 9

The computer-implemented method as in any one of examples 1 to 8, wherein the animation object of the scene defined in each keyframe is displayed as an avatar within the virtual environment, and wherein receiving the keyframe edit command includes receiving data representing a movement of the avatar within the virtual environment.

### EXAMPLE 10

The computer-implemented method as in any one of examples 1 to 9, wherein each of the plurality of keyframes defines a starting and/or ending point of a smooth transition of the animation object from a first position to a second position.

### EXAMPLE 11

The computer-implemented method as in any one of examples 1 to 10, wherein the plurality of keyframes forms part of an animation sequence, and wherein the aspect of the particular keyframe identified by the keyframe edit command in response to receiving the edit command is changed during a recording of the animation sequence.

### EXAMPLE 12

A computer program product comprising a nontransitive storage medium, the computer program product including code that, when executed by processing circuitry of a computer, causes the processing circuitry to perform a method, the method comprising: receiving data defining a virtual environment and a plurality of keyframes, each keyframe from the plurality of keyframes defining a scene including an animation object at a respective point in time; displaying the virtual environment and at least one of the plurality of keyframes within the virtual environment on a virtual reality display; receiving, from a virtual reality controller, a keyframe identification command identifying a particular keyframe of the at least one of the plurality of keyframes displayed within the virtual environment on the virtual reality display; in response to receiving the keyframe identification command, displaying the particular keyframe within the virtual environment on a virtual reality display; and receiving, from the virtual reality controller, a keyframe edit command identifying an aspect of the particular keyframe; and in response to receiving the edit command, changing the aspect of the particular keyframe identified by the keyframe edit command.

### EXAMPLE 13

The computer program product of example 12, wherein the animation object moves in a first trajectory within the virtual environment between an initial time and a final time during the scene; wherein the particular keyframe defines the animation object at a point in time prior to the final time; and wherein the method further comprises generating a second trajectory over which the animation object is defined between the point in time and the final time.

### EXAMPLE 14

The computer program product of example 13, wherein the method further comprises, in response to generating the second trajectory, displaying a ghost animation object on the virtual reality display, the ghost animation object moving in the first trajectory within the virtual environment between the point in time and the final time during the scene.

### EXAMPLE 15

The computer program product of any one of examples 12 to 14, wherein the animation object includes a set of contact points, each of the set of contact points providing a point on the animation object at which the virtual reality controller causes the aspect of the animation object to change between adjacent keyframes; and wherein changing the aspect of the identified keyframe includes translating one of the set of contact points to a new position within the virtual environment.

### EXAMPLE 16

The computer program product as in example 15, wherein the virtual reality controller includes a six-degree-of-freedom (6 DOF) controller, and wherein changing the aspect of the identified keyframe further includes rotating the contact point about an axis within the virtual environment.

### EXAMPLE 17

The computer program product as in example 15, wherein changing the aspect of the identified keyframe includes adding a new contact point to the set of contact points of the animation object at the identified keyframe.

### EXAMPLE 18

The computer program product as in any one of examples 12 to 17, wherein the method further comprises, in response to receiving the edit command, adding another animation object to the scene at the identified keyframe.

### EXAMPLE 19

The computer program product as in any one of examples 12 to 18, wherein changing the aspect of the identified keyframe includes changing a size of the animation object within the virtual environment.

### EXAMPLE 20

An electronic apparatus, comprising: a network interface; memory; and controlling circuitry coupled to the memory, the controlling circuitry being constructed and arranged to: receive data defining a virtual environment and a plurality of keyframes, each keyframe from the plurality of keyframes defining a scene including an animation object at a respective point in time; display the virtual environment and at least one of the plurality of keyframes within the virtual environment on a virtual reality display; receive, from a virtual reality controller, a keyframe identification command identifying a particular keyframe of the at least one of the plurality of keyframes displayed within the virtual environment on the virtual reality display; in response to receiving the keyframe identification command, display the particular keyframe within the virtual environment on a virtual reality display; and receive, from the virtual reality controller, a keyframe edit command identifying an aspect of the particular keyframe; and in response to receiving the edit command, change the aspect of the particular keyframe identified by the keyframe edit command.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method, the method comprising:
receiving data defining a virtual environment and a plurality of keyframes, each keyframe from the plurality of keyframes defining a scene including an animation object at a respective point in time;
displaying the virtual environment and at least one of the plurality of keyframes within the virtual environment on a virtual reality display;
receiving, from a virtual reality controller, a keyframe identification command identifying a particular keyframe of the at least one of the plurality of keyframes displayed within the virtual environment on the virtual reality display;
in response to receiving the keyframe identification command, displaying the particular keyframe within the virtual environment on a virtual reality display; and
receiving, from the virtual reality controller, a keyframe edit command identifying an aspect of the particular keyframe; and
in response to receiving the edit command, changing the aspect of the particular keyframe identified by the keyframe edit command.

2. The computer-implemented method of claim 1, wherein the animation object moves in a first trajectory within the virtual environment between an initial time and a final time during the scene;
wherein the particular keyframe defines the animation object at a point in time prior to the final time; and
wherein the method further comprises generating a second trajectory over which the animation object is defined between the point in time and the final time.

3. The computer-implemented method of claim 2, further comprising, in response to generating the second trajectory, displaying a ghost animation object on the virtual reality display, the ghost animation object moving in the first trajectory within the virtual environment between the point in time and the final time during the scene.

4. The computer-implemented method of claim 1, wherein the animation object includes a set of contact points, each of the set of contact points providing a point on the animation object at which the virtual reality controller causes the aspect of the animation object to change between adjacent keyframes; and
wherein changing the aspect of the identified keyframe includes translating one of the set of contact points to a new position within the virtual environment.

5. The computer-implemented method as in claim 4, wherein the virtual reality controller includes a six-degree-of-freedom (6 DOF) controller, and
wherein changing the aspect of the identified keyframe further includes rotating the contact point about an axis within the virtual environment.

6. The computer-implemented method as in claim 4, wherein changing the aspect of the identified keyframe includes adding a new contact point to the set of contact points of the animation object at the identified keyframe.

7. The computer-implemented method as in claim 1, further comprising, in response to receiving the edit command, adding another animation object to the scene at the identified keyframe.

8. The computer-implemented method as in claim 1, wherein changing the aspect of the identified keyframe includes changing a size of the animation object within the virtual environment.

9. The computer-implemented method as in claim 1, wherein the animation object of the scene defined in each keyframe is displayed as an avatar within the virtual environment, and
wherein receiving the keyframe edit command includes receiving data representing a movement of the avatar within the virtual environment.

10. The computer-implemented method as in claim 1, wherein each of the plurality of keyframes defines a starting and/or ending point of a smooth transition of the animation object from a first position to a second position.

11. The computer-implemented method as in claim 1, wherein the plurality of keyframes forms part of an animation sequence, and
wherein the aspect of the particular keyframe identified by the keyframe edit command in response to receiving the edit command is changed during a recording of the animation sequence.

12. A computer program product comprising a nontransitive storage medium, the computer program product including code that, when executed by processing circuitry of a computer, causes the processing circuitry to perform a method, the method comprising:
receiving data defining a virtual environment and a plurality of keyframes, each keyframe from the plurality of keyframes defining a scene including an animation object at a respective point in time;
displaying the virtual environment and at least one of the plurality of keyframes within the virtual environment on a virtual reality display;
receiving, from a virtual reality controller, a keyframe identification command identifying a particular keyframe of the at least one of the plurality of keyframes displayed within the virtual environment on the virtual reality display;
in response to receiving the keyframe identification command, displaying the particular keyframe within the virtual environment on a virtual reality display; and
receiving, from the virtual reality controller, a keyframe edit command identifying an aspect of the particular keyframe; and
in response to receiving the edit command, changing the aspect of the particular keyframe identified by the keyframe edit command.

13. The computer program product of claim 12, wherein the animation object moves in a first trajectory within the virtual environment between an initial time and a final time during the scene;
wherein the particular keyframe defines the animation object at a point in time prior to the final time; and
wherein the method further comprises generating a second trajectory over which the animation object is defined between the point in time and the final time.

14. The computer program product of claim 13, wherein the method further comprises, in response to generating the second trajectory, displaying a ghost animation object on the virtual reality display, the ghost animation object moving in the first trajectory within the virtual environment between the point in time and the final time during the scene.

15. The computer program product of claim 12, wherein the animation object includes a set of contact points, each of the set of contact points providing a point on the animation object at which the virtual reality controller causes the aspect of the animation object to change between adjacent keyframes; and
wherein changing the aspect of the identified keyframe includes translating one of the set of contact points to a new position within the virtual environment.

16. The computer program product as in claim 15, wherein the virtual reality controller includes a six-degree-of-freedom (6 DOF) controller, and wherein changing the aspect of the identified keyframe further includes rotating the contact point about an axis within the virtual environment.

17. The computer program product as in claim 15, wherein changing the aspect of the identified keyframe includes adding a new contact point to the set of contact points of the animation object at the identified keyframe.

18. The computer program product as in claim 12, wherein the method further comprises, in response to receiving the edit command, adding another animation object to the scene at the identified keyframe.

19. The computer program product as in claim 12, wherein changing the aspect of the identified keyframe includes changing a size of the animation object within the virtual environment.

20. An electronic apparatus, comprising:
a network interface;
memory; and
controlling circuitry coupled to the memory, the controlling circuitry being constructed and arranged to:
receive data defining a virtual environment and a plurality of keyframes, each keyframe from the plurality of keyframes defining a scene including an animation object at a respective point in time;
display the virtual environment and at least one of the plurality of keyframes within the virtual environment on a virtual reality display;
receive, from a virtual reality controller, a keyframe identification command identifying a particular keyframe of the at least one of the plurality of keyframes displayed within the virtual environment on the virtual reality display;
in response to receiving the keyframe identification command, display the particular keyframe within the virtual environment on a virtual reality display; and
receive, from the virtual reality controller, a keyframe edit command identifying an aspect of the particular keyframe; and
in response to receiving the edit command, change the aspect of the particular keyframe identified by the keyframe edit command.
